(19) United States
(12) Patent Application Publication
(10) Pub. No.: US 2024/0161175 A1
(43) Pub. Date: May 16, 2024

(54) INTELLIGENT ASSISTANCE FOR SELECTION AND DEVELOPMENT OF WIRELESS SITE CANDIDATES

(71) Applicant: DISH Wireless L.L.C., Englewood, CO (US)

(72) Inventors: Alexia Zupancic, Englewood, CO (US); Craig Lincoln Krammes, Highland, MD (US)

(21) Appl. No.: 17/986,360

(22) Filed: Nov. 14, 2022

(51) Int. Cl. G06Q 30/06

(52) U.S. Cl. CPC G06Q 30/0637

(57) ABSTRACT

A method includes obtaining data corresponding to a plurality of candidate wireless sites, and processing the data for at least a subset of the candidate wireless sites, to identify one or more line items of a purchase order (PO) to recommend for cancellation. Processing the data includes determining that the PO corresponding to at least one candidate wireless site has been approved, determining that at least one line item of the PO has not been cancelled, determining that no invoice has been received that corresponds to the at least one line item of the PO, and determining that the at least one candidate wireless site is not actively being pursued for development. The method also includes generating one or more alerts including an identification of the at least one line item of the PO and a recommendation to cancel the at least one line item of the PO; and presenting, on a graphical user interface, the one or more alerts to the user.

### TECHNICAL FIELD

This specification relates to the selection and development of wireless site candidates (e.g., candidate cell sites). Wireless sites can be used to support wireless networks such as 5G cellular networks.

### BACKGROUND

Networks such as 5G cellular networks have been developed to connect people, machines, objects, and devices.

### SUMMARY

The present disclosure relates to the management (e.g., the selection and development) of wireless site candidates such as candidate cell sites. In cellular networks (e.g., 3G networks, 4G networks, 5G networks, etc.), wireless sites can serve as locations for placing antennas and/or other communications equipment (e.g., to establish a base station). Selecting wireless sites can be a complex process, including consideration of many disparate pieces of information to determine a desirable geographic location and type (e.g., a rooftop, a tower, or an alternative structure) for the wireless site. Even after selecting a candidate wireless site to pursue, developing the wireless site can also be a complex process, involving interactions with multiple vendors, meeting various deadlines for different deliverables, and exchanging documents such as purchase orders (POs), invoices, and deliverables.

In some cases, a party operating a large cellular network may consider and develop many candidate wireless sites simultaneously (e.g., greater than 100 candidate wireless sites, greater than 500 candidate wireless sites, greater than 1,000 candidate wireless sites, greater than 10,000 candidate wireless sites, etc.). Given the large amounts of data, documents, and deadlines corresponding with each individual candidate wireless site, managing many candidate wireless sites simultaneously can become impractical or infeasible for a human being using existing technologies. Typically, data relating to candidate sites are stored in large spreadsheets, which a user could scroll through to find critical information about each candidate site. However, this process can result in problems such as unnoticed missed deadlines, unnecessary costs (e.g., paying for services that are no longer needed because a candidate wireless site is no longer being pursued), and unnoticed missing documents (e.g., a missing purchase order, a missing deliverable document, a missing invoice, etc.).

The technology disclosed herein provides a technical solution to the problems described above by automatically and intelligently processing large amounts of data related to candidate wireless sites (e.g., hundreds of candidate wireless sites, thousands of candidate wireless sites, tens of thousands of candidate wireless sites, etc.) to identify potential issues related to the candidate wireless sites, and then prompting a user to take one or more particular actions to resolve the potential issues. For example, the potential issues can include a missing PO, a missing deliverable document, and/or a missing invoice for a candidate wireless site. In response to identifying such an issue, an alert can be generated and presented to the user to prompt the user to issue the missing document(s) and/or contact a vendor to obtain the missing document(s). In another example, the potential issue can include an outstanding PO that has not been invoiced and is no longer necessary since it is related to a candidate wireless site that is no longer being pursued. In response to identifying the issue, an alert can be generated and presented to the user to cancel the unnecessary PO.

In some implementations, the technology disclosed herein can bring together various data related to a candidate wireless site (e.g., candidate information, location information, RF information, population coverage data, milestone and task dates, forecasts, decommission data for other network providers, business term agreement negotiation status, etc.) for presentation in a single page, enabling easy review and updating of the data (e.g., without the need to scroll). The alerts described above can also be presented to the user on this page. In some implementations, the page can further include indications of missed deadlines, rejected documents, and/or a measured time spent in one or more development phases of the wireless site. In some implementations, on the same page and/or on a separate page, the technology described herein can present information about approved POs issued for each candidate wireless site and line item details about work to be performed by vendors for each site.

In some implementations, the technology described herein can also include analytic filters to enable a user to quickly identify candidate wireless sites by project team members in certain organizational roles (e.g., manager, RF engineer, site acquisition specialist, etc.), by vendor, by attributes like site type (e.g., rooftop, tower, alternative structure, etc.), or by a phase of development that the site is currently in.

The technology described herein is not limited to candidate wireless sites only, but can be used for any wireless sites (e.g., former candidate wireless sites that are currently in full operation). Many of the challenges associated with managing large numbers of candidate wireless sites are similar to those encountered when managing a cellular network that includes a large number of actualized wireless sites (e.g., wireless sites in full operation), and the technology disclosed herein can be readily applied to such use cases. Accordingly, while the term “candidate wireless site” is used throughout the specification, it is to be understood that the technology described herein can apply to “wireless sites” more generally, unless otherwise specified.

In one aspect, a method is featured. The method includes obtaining data corresponding to a plurality of candidate wireless sites, the data comprising an indication of whether each of the candidate wireless sites is actively being pursued for development, a representation of a status of one or more tasks related to developing each of the candidate wireless sites, a record of an issuance or receipt of one or more documents related to the one or more tasks, and a representation of a status of the one or more documents. The method also includes processing the data, for at least a subset of the candidate wireless sites, to identify one or more line items of a purchase order to recommend for cancellation. Processing the data includes determining that the purchase order corresponding to at least one candidate wireless site has been approved, determining that at least one line item of the purchase order has not been cancelled, determining that no invoice has been received that corresponds to the at least one line item of the purchase order, and determining that the at least one candidate wireless site is not actively being pursued for development. The method also includes generating one or more alerts including an identification of the at least one line item of the purchase order and a recommendation to cancel the at least one line item of the purchase order; and presenting, on a graphical user interface, the one or more alerts to the user.

Implementations can include the examples described below and herein elsewhere. In some implementations, the method can include processing the data to detect a missing invoice, wherein processing the data includes determining that a second purchase order has been issued and determining that no invoice has been received that corresponds to the second purchase order. In some implementations, the method can include generating a missing invoice alert including a recommendation to contact a vendor responsible for supplying the missing invoice. In some implementations, the method can include processing the data to detect a missing purchase order, wherein processing the data includes determining that an invoice has been received and determining that no purchase order has been issued that corresponds to the invoice. In some implementations, the method can include generating a missing purchase order alert including a recommendation to issue the missing purchase order. In some implementations, the method can include processing the data to detect a missing deliverable document, wherein processing the data includes determining that a second purchase order has been issued, determining that an invoice corresponding to the second purchase order has been received, and determining that no deliverable document corresponding to the second purchase order or the invoice has been received. In some implementations, the method can include generating a missing deliverable document alert including a recommendation to contact a vendor responsible for supplying the missing deliverable document. In some implementations, presenting the one or more alerts to the user can include presenting the one or more alerts with a visualization of at least a portion of the data corresponding to the plurality of candidate wireless sites, wherein an entirety of the visualization is viewable on a display of a user device at one time. In some implementations, the data corresponding to the plurality of candidate wireless sites can include data corresponding to more than 1,000 candidate wireless sites.

In another aspect, a computing device is featured. The computing device includes a display and a controller operably connected to the display, the controller configured to execute instructions to perform operations. The operations include obtaining data corresponding to a plurality of candidate wireless sites, the data including an indication of whether each of the candidate wireless sites is actively being pursued for development, a representation of a status of one or more tasks related to developing each of the candidate wireless sites, a record of an issuance or receipt of one or more documents related to the one or more tasks, and a representation of a status of the one or more documents. The operations also include processing the data, for at least a subset of the candidate wireless sites, to identify one or more line items of a purchase order to recommend for cancellation. Processing the data includes determining that the purchase order corresponding to at least one candidate wireless site has been approved, determining that at least one line item of the purchase order has not been cancelled, determining that no invoice has been received that corresponds to the at least one line item of the purchase order, and determining that the at least one candidate wireless site is not actively being pursued for development. The operations also include generating one or more alerts including an identification of the at least one line item of the purchase order and a recommendation to cancel the at least one line item of the purchase order; and presenting the one or more alerts to the user on a graphical user interface shown on the display.

Implementations can include the examples described below and herein elsewhere. In some implementations, the operations can include processing the data to detect a missing invoice, wherein processing the data includes determining that a second purchase order has been issued and determining that no invoice has been received that corresponds to the second purchase order. In some implementations, the operations can include generating a missing invoice alert including a recommendation to contact a vendor responsible for supplying the missing invoice. In some implementations, the operations can include processing the data to detect a missing purchase order, wherein processing the data includes determining that an invoice has been received and determining that no purchase order has been issued that corresponds to the invoice. In some implementations, the operations can include generating a missing purchase order alert including a recommendation to issue the missing purchase order. In some implementations, the operations can include processing the data to detect a missing deliverable document, wherein processing the data includes determining that a second purchase order has been issued, determining that an invoice corresponding to the second purchase order has been received, and determining that no deliverable document corresponding to the second purchase order or the invoice has been received. In some implementations, the operations can include generating a missing deliverable document alert including a recommendation to contact a vendor responsible for supplying the missing deliverable document. In some implementations, presenting the one or more alerts to the user can include presenting the one or more alerts with a visualization of at least a portion of the data corresponding to the plurality of candidate wireless sites, wherein an entirety of the visualization is viewable on a display of a user device at one time. In some implementations, the data corresponding to the plurality of candidate wireless sites can include data corresponding to more than 1,000 candidate wireless sites.

In another aspect, a non-transitory computer readable medium is featured. The non-transitory computer readable medium stores instructions that are executable by a processing device, and upon such execution cause the processing device to perform operations. The operations include obtaining data corresponding to a plurality of candidate wireless sites, the data including an indication of whether each of the candidate wireless sites is actively being pursued for development, a representation of a status of one or more tasks related to developing each of the candidate wireless sites, a record of an issuance or receipt of one or more documents related to the one or more tasks, and a representation of a status of the one or more documents. The operations also include processing the data, for at least a subset of the candidate wireless sites, to identify one or more line items of a purchase order to recommend for cancellation. Processing the data includes determining that the purchase order corresponding to at least one candidate wireless site has been approved, determining that at least one line item of the purchase order has not been cancelled, determining that no invoice has been received that corresponds to the at least one line item of the purchase order, and determining that the at least one candidate wireless site is not actively being pursued for development. The operations also include generating one or more alerts including an identification of the at least one line item of the purchase order and a recommendation to cancel the at least one line item of the purchase order; and presenting the one or more alerts to the user on a graphical user interface shown on the display.

Implementations can include the examples described below and herein elsewhere. In some implementations, the operations can include processing the data to detect a missing invoice, wherein processing the data includes determining that a second purchase order has been issued and determining that no invoice has been received that corresponds to the second purchase order. In some implementations, the operations can include generating a missing invoice alert including a recommendation to contact a vendor responsible for supplying the missing invoice. In some implementations, the operations can include processing the data to detect a missing purchase order, wherein processing the data includes determining that an invoice has been received and determining that no purchase order has been issued that corresponds to the invoice. In some implementations, the operations can include generating a missing purchase order alert including a recommendation to issue the missing purchase order. In some implementations, the operations can include processing the data to detect a missing deliverable document, wherein processing the data includes determining that a second purchase order has been issued, determining that an invoice corresponding to the second purchase order has been received, and determining that no deliverable document corresponding to the second purchase order or the invoice has been received. In some implementations, the operations can include generating a missing deliverable document alert including a recommendation to contact a vendor responsible for supplying the missing deliverable document. In some implementations, presenting the one or more alerts to the user can include presenting the one or more alerts with a visualization of at least a portion of the data corresponding to the plurality of candidate wireless sites, wherein an entirety of the visualization is viewable on a display of a user device at one time. In some implementations, the data corresponding to the plurality of candidate wireless sites can include data corresponding to more than 1,000 candidate wireless sites.

Various implementations of the technology described herein may provide one or more of the following advantages.

Compared to using large spreadsheets that compile information from many candidate wireless sites that a user must scroll through, the technology described herein can allow for easier and more rapid navigation and identification of data related to candidate wireless sites. In addition, unlike static spreadsheets, the technology described herein is able to process large amounts of data relating to candidate wireless sites to identify potential issues and automatically generate alerts that prompt a user to take one or more particular actions to resolve the identified potential issues. Therefore, the technology described herein can also have the advantage of calling attention to and reducing missed deadlines, unnecessary costs, and missing documents that might otherwise go unnoticed.

Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF THE DRAWINGS

FIGS. 1-4 are screenshots of a user interface.

FIG. 5 is a flowchart of a process for presenting an alert corresponding to one or more potential issues related to at least one candidate wireless site to a user.

FIG. 6 is a diagram illustrating an example of a computing environment.

### DETAILED DESCRIPTION

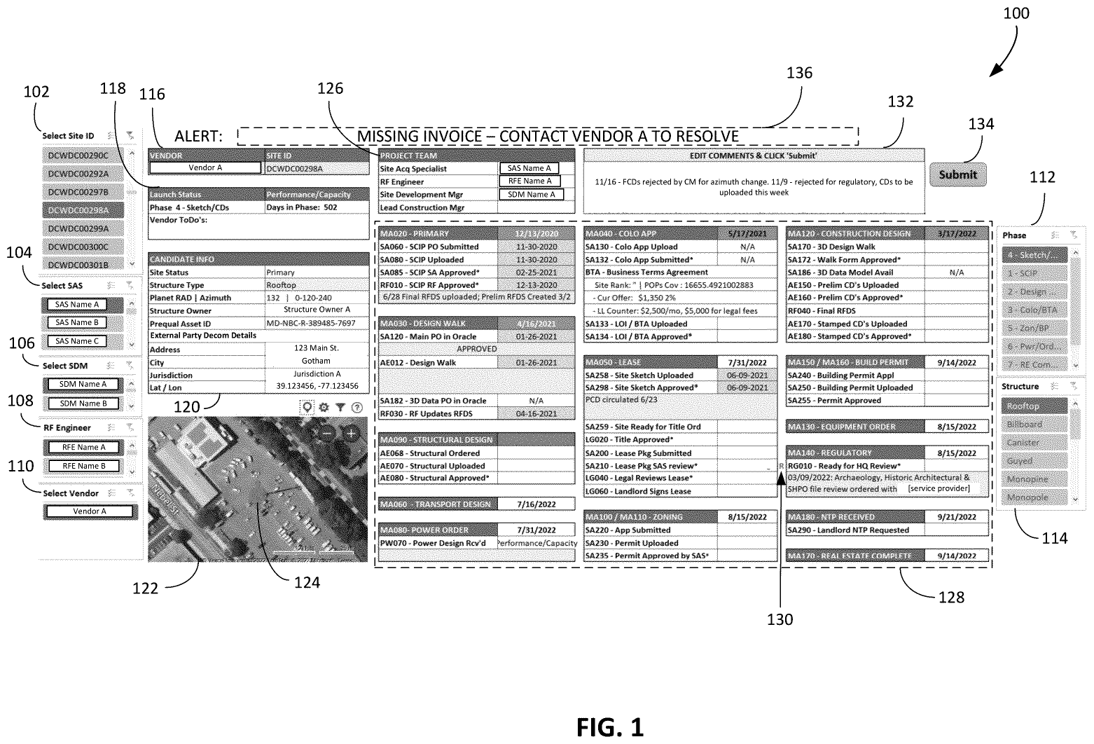

FIG. 1 is a screenshot 100 of a user interface associated with the technology described herein. For example, the screenshot can be taken of a display of a user device such as a personal computer, laptop, tablet, smartphone, or other mobile computing device. In some implementations, the user interface shown in the screenshot 100 can be presented on the display of a user device in response to the user running a software application (e.g., Microsoft Excel®, Google Sheets™, Tableau®, a custom-made software application, etc.) on the user device. In some implementations, the user interface shown in the screenshot 100 can be presented on the display of the user device in response to the user opening a particular file (e.g., a digital file) using the software application.

Various example features of the user interface are described herein. In some implementations, additional or fewer features can be included in the user interface. Furthermore, while the features described with reference to the example screenshots 100, 200, 300, 400 shown in FIGS. 1-4 are shown having particular spatial relationships to one another, in some implementations, the visual features of the user interface can be rearranged, for example, depending on an aspect ratio and/or size of a particular user device's display, depending on a user's preferences, depending on a relevance of each feature, etc.

The screenshot 100 shown in FIG. 1 captures a first view (referred to herein as a “Deployment Summary View”) of the user interface that, among other things, enables a user to quickly search for a wireless site (or candidate wireless site), displays information about the site, allows a user to submit comments regarding the site, and presents alerts to the user about one or more potential issues related to the site (including recommended actions to be taken by the user to resolve the one or more potential issues). The Deployment Summary View can show, in a flexible framework, important tasks that need to be accomplished for a particular candidate wireless site in order to bring that site to a constructed and/or operable state. The various information shown in the Deployment Summary View can, in some implementations, be pulled from a local copy of data downloaded from an external source (e.g., one or more external servers owned by a network provider). In other implementations, the information can be pulled directly from the external source (e.g., in real-time).

The Deployment Summary View of the user interface includes a scrollable list 102 of candidate wireless site IDs, in which each site ID is selectable by a user to view further information about the corresponding site. In some implementations, the user interface can include an indication of a number of site IDs available for selection in the scrollable list 102.

In order to assist a user with quickly identifying a particular candidate wireless site, the user interface can include various drop-down selectors (e.g., drop-down selectors 104, 106, 108, 110, 112, 114), which allow the user to filter the candidate wireless sites and their corresponding site IDs presented in the scrollable list 102. For example, drop-down selector 104 can allow a user to filter the site IDs presented in the scrollable list 102 by a Site Acquisition Specialist (SAS) associated with each candidate wireless site. Drop-down selector 106 can allow a user to filter the site IDs presented in the scrollable list 102 by a Site Development Manager (SDM) associated with each candidate wireless site. Drop-down selector 108 can allow a user to filter the site IDs presented in the scrollable list 102 by a Radio Frequency Engineer (RF Engineer) associated with each candidate wireless site. Drop-down selector 110 can allow a user to filter the site IDs presented in the scrollable list 102 by a vendor associated with each candidate wireless site. Drop-down selector 112 can allow a user to filter the site IDs presented in the scrollable list 102 by a phase of development that the candidate wireless site is currently in. Drop-down selector 114 can allow a user to filter the site IDs presented in the scrollable list 102 by a type of structure corresponding to the candidate wireless site (e.g., a rooftop, billboard, canister, guyed, monopine, monopole, etc.). In some implementations, multiple options can be selected within each drop-down selector. In some implementations, one or more of the drop-down selectors 104, 106, 108, 110, 112, 114 can be used in conjunction to decrease the number of site IDs presented in the scrollable list 102.

Upon identifying a candidate wireless site of interest, the user can select a site ID corresponding to the candidate wireless site of interest in the scrollable list 102. The selection of the site ID can cause the Deployment Summary View of the user interface to display information about the candidate wireless site of interest. For example, visual element 116 can display the name of a site acquisition vendor and the site ID corresponding to the candidate wireless site of interest. Visual element 118 can display a launch status (sometimes referred to herein as a “launch category”) of the candidate wireless site (here, shown as “Performance/Capacity”), a phase of development that the candidate wireless site is in (e.g., “Phase 4—Sketch/CDs”), a number of days that the candidate wireless site has been in the current phase of development, and a list of action items for the site acquisition vendor to perform. Visual element 120 can include a site status representing a status of a candidate wireless site within a site acquisition process. For example, the site status can be “Search Ring,” meaning that the candidate wireless site is a potential candidate within a search ring (e.g., a defined geographic area or “ring” having, for example, a radius between 1 and 10 miles). In some cases, the site status can be “Primary,” meaning that the candidate wireless site has been identified as the best candidate within the search ring and/or that the candidate wireless site is being pursued for development. In some cases, the site status can be “On Hold,” meaning that the site acquisition process for the candidate wireless site has been halted due to one or more problems and/or due to an ongoing process of identifying a better candidate wireless site within the same search ring. In some cases, the site status can be “Fallout,” meaning that the candidate wireless site is no longer being pursued for development due to, for example, a lack of interest in the site. In some cases, the site status can be “RF Inactive,” meaning that the candidate wireless site has been discarded and will no longer be considered for possible antenna placement. Visual element 120 can also include a structure type; a “Planet RAD” (e.g., a height at which communications equipment such as an antenna is planned to be installed) and azimuth; a structure owner; an alternative identification code (e.g., “a Prequal Asset ID”) for the candidate wireless site that may be used, for example, in a different data storage unit; details about the decommissioning of the candidate wireless site by an external party (e.g., another network provider); and location information associated with the candidate wireless site. Visual element 126 can include information about a project team associated with the candidate wireless site, including details about a Site Acquisition Specialist (SAS), a RF Engineer, a Site Development Manager (SDM), and/or a Lead Construction Manager associated with the candidate wireless site.

In some implementations, the Deployment Summary View of the user interface can further include a map 122 including a marker 124 that indicates the location (or proposed location) of the candidate wireless site. The map can be interactive, allowing the user to observe satellite imagery of the surrounding area.

The Deployment Summary View of the user interface can further include information about major milestones associated with the candidate wireless site of interest (e.g., in section 128). The term “major milestones” is used herein to refer to tasks for which forecast dates are set that need to be accomplished by either a network provider or by one or more vendors in order to bring that site to a constructed and/or operable state. Examples of major milestones that can be included in section 128 of the Deployment Summary View include: a primary milestone (e.g., “MA020—PRIMARY”), a design walk milestone (e.g., “MA030—DESIGN WALK”), a structural design milestone (e.g., “MA090—STRUCTURAL DESIGN”), a transport design milestone (e.g., “MA060—TRANSPORT DESIGN”), a power order milestone (e.g., “MA080—POWER ORDER”), a colocation application milestone (e.g., “MA040—COLO APP”), a lease milestone (e.g., “MA050—LEASE”), a zoning milestone (e.g., “MA100/MA110—ZONING”), a construction design milestone (e.g., “MA120—CONSTRUCTION DESIGN”), a building permit milestone (e.g., “MA150MA160—BUILD PERMIT”), an equipment order milestone (e.g., “MA130—EQUIPMENT ORDER”), a regulatory milestone (e.g., “MA140—REGULATORY”), a notice to proceed (NTP) milestone (e.g., “MA180—NTP RECEIVED”), and a real estate completion milestone (e.g., “MA170—REAL ESTATE COMPLETE”).

Each major milestone can be assigned a forecasted date for completion, which can be displayed adjacent to the corresponding milestone name in section 128 of the Deployment Summary View. In some implementations, one or more indications (e.g., cell color indications, font color indications, font type indications, line type indications, etc.) can be used to distinguish between forecast dates that have been met, forecast dates that have not been met but have not yet passed, and forecast dates that have passed without being met. Such indications can enable a user to quickly visually identify milestones that have fallen behind their forecasted schedule for completion. In some implementations, the one or more indications can also be used to indicate that a document associated with a particular milestone or sub-task was uploaded, but was ultimately rejected. In some implementations, the rejected document can be deleted, and a mark 130 (here, shown as an “R”) can be displayed in the Deployment Summary View to notify a user that the document was rejected.

In section 128 of the Deployment Summary View, the presentation of each major milestone can include the presentation of smaller sub-tasks having their own forecast dates displayed adjacent to the corresponding sub-task name. For example, the presentation of a primary milestone (e.g., “MA020—PRIMARY”) can include the presentation of several sub-tasks (e.g., “SA060—SCIP PO Submitted”, “SA080—SCIP Uploaded”, “SA085—SCIP SA Approved”, “RF010—SCIP RF Approved”) related to a Site Candidate Information Package (SCIP) associated with the candidate wireless site of interest. In another example, the presentation of a structural design milestone (e.g., “MA090—STRUCTURAL DESIGN”) can include the presentation of several sub-tasks including the ordering of a structural design (e.g., “AE068—Structural Ordered”), the uploading of the structural design by a vendor (e.g., “AE070—Structural Uploaded”), and the approval of the structural design (e.g., “AE080—Structural Approved”). In some implementations, the sub-tasks can be presented in the same visual element (e.g., a single display block) as the major milestone to which the sub-tasks correspond.

In some implementations, in section 128 of the Deployment Summary View, the presentation of certain sub-tasks can be accompanied by a free-text field, which can include free-text notes associated with the sub-tasks. For example, a free-text field beneath “RF010—SCIP RF Approved” can include free-text notes about the RF approval. A free-text field beneath “SA120—Main PO in Oracle” can include free-text notes about the status of one or more main POs. A free text-field beneath “AE012—Design Walk” can include free-text design walk notes captured during a rooftop visit. A free-text field beneath “PW070—Power Design Rcv'd” can include free-text notes indicating if there are open meter slots or if new power is required for the site. A free-text field beneath “SA298—Site Sketch Approved” can include free-text notes about a site sketch associated with the candidate wireless site of interest. A free-text field beneath “RG010—Ready for HQ Review” can include free-text notes such as feedback received from a regulatory team about documents that were rejected after the team's review.

In addition to allowing a user to quickly identify a candidate wireless site and view important information about it, the Deployment Summary View shown in screenshot 100 can also allow a user to view, edit, and add comments about the candidate wireless site for future reference. Existing comments about the candidate wireless site can be displayed in the comment box 132. For example, as shown in FIG. 1, the comments can provide additional context about rejected documents, upcoming deliverables, and/or any other relevant information. The comments shown in the comment box 132 can be edited or added onto by a user, who can then save the updated comments by selecting the “Submit” button 134. In some implementations, selection of the “Submit” button 134 can ensure that the updated comments persist when the user accesses the same candidate wireless site using the Deployment Summary View at a later time. In some implementations, selection of the “Submit” button 134 can cause the updated comments to be pushed to an external server and/or overwrite the existing comments stored in an external database containing data about a plurality of wireless sites. In some implementations, selection of the “Submit” button 134 can cause the updated comments to overwrite the existing comments stored in a local copy of the data. In some implementations, selection of the “Submit” button 134 saves not only the updated comments themselves, but also metadata including a timestamp of the submission and/or a number of times that the comments have been updated.

The Deployment Summary View shown in screenshot 100 can further include one or more alerts 136 corresponding to one or more potential issues related to the candidate wireless site of interest. The alerts 136 can be generated to identify the one or more potential issues and/or include a recommended action to be taken by a user to resolve the one or more potential issues. For example, the one or more potential issues can include the existence of an outstanding PO (e.g., a line item of a PO that has not been invoiced) corresponding to a candidate wireless site that is no longer being pursued for development. In this example, the alert 136 can identify the potential issue and/or include the recommended action of cancelling the line item of the purchase order. In another example (as shown in FIG. 1), the one or more potential issues can include a missing invoice corresponding to an issued PO. In this example, the alert 136 can identify the potential issue and/or include the recommended action of contacting a vendor responsible for supplying the missing invoice. In another example, the one or more potential issues can include a missing PO corresponding to an invoice that has been received. In this example, the alert 136 can identify the potential issue and/or include the recommended action of issuing the missing PO. In another example, the one or more potential issues can include a missing deliverable document (e.g., documents provided by a service provider or vendor after performing a deliverable task). In this example, the alert 136 can identify the potential issue and/or include the recommended action of contacting a vendor responsible for supplying the missing deliverable document. The steps for processing the data corresponding to the candidate wireless sites to detect the one or more potential issues are described in further detail herein.

In some implementations, an interactive element (e.g., a selectable button icon) can be presented to a user viewing the Deployment Summary View to enable the user to automatically perform the recommended action included in the alert 136. For example, if the alert 136 includes a recommended action of cancelling a line item of a purchase order, the user can interact with the interactive element to automatically send an email to the relevant vendor to cancel the line item of the purchase order (e.g., without requiring the user to draft and send the email themselves). In another example, if the alert 136 includes a recommended action of contacting a vendor responsible for supplying the missing invoice, the user can interact with the interactive element to automatically send an email to the vendor to request the missing invoice. In another example, if the alert 136 includes a recommended action of issuing a missing PO, the user can interact with the interactive element to automatically generate a PO form, which the user can then edit before sending to the relevant party.

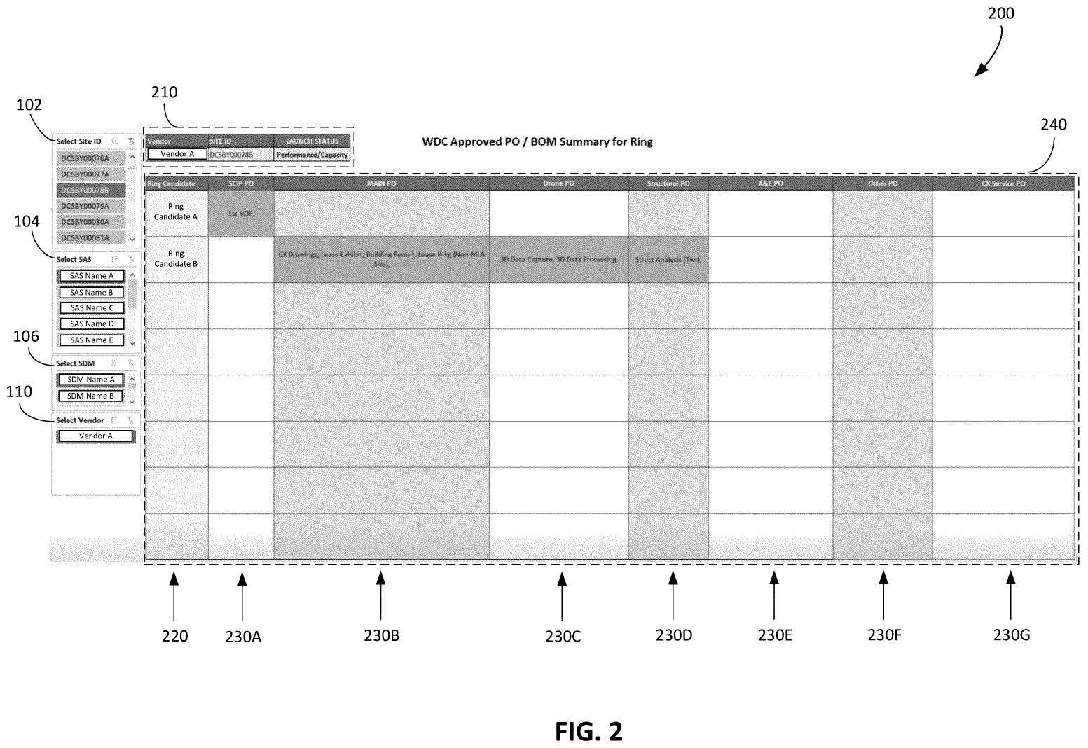

FIG. 2 is another screenshot 200 of a user interface associated with the technology described herein. The screenshot 200 captures a second view (referred to herein as a “PO-BOM Summary View” or a “Purchase Order-Bill of Materials Summary View”) of the user interface that, among other things, shows what POs have been approved and issued for a candidate wireless site of interest (as well as for other candidates considered within the same geographic area or “ring”). The various information shown in the PO-BOM Summary View can, in some implementations, be pulled from a local copy of data downloaded from an external source (e.g., one or more external servers owned by a network provider). In other implementations, the information can be pulled directly from the external source (e.g., in real-time).

Like the Deployment Summary View, the PO-BOM Summary View includes a scrollable list 102 of candidate wireless site IDs, in which each site ID is selectable by a user to view further information about the corresponding site. Again, like the Deployment Summary View, the PO-BOM Summary View can also include various drop-down selectors (e.g., drop-down selectors 104, 106, 110), which allow the user to easily filter the candidate wireless sites and their corresponding site IDs presented in the scrollable list 102. The drop-down selectors included in the PO-BOM Summary View may or may not exactly match the drop-down selectors included in the Deployment Summary View.

Upon identifying a candidate wireless site of interest in the PO-BOM Summary View, the user can select a site ID corresponding to the candidate wireless site of interest in the scrollable list 102. The selection of the site ID can cause the PO-BOM Summary View shown in the screenshot 200 to display information about the candidate wireless site of interest (as well as information about other candidate wireless sites considered within the same geographic ring). For example, the visual element 210 can include basic information about the candidate wireless site of interest such as a site acquisition vendor, a site ID, and a launch status associated with the candidate wireless site. The visual element 240, meanwhile, can include more detailed information about POs associated with the candidate wireless site and alternative candidates considered within the same geographic ring.

The visual element 240 includes a “Ring Candidate” column 220 that identifies candidate wireless sites considered within a particular geographic area (or “ring”), with each candidate corresponding to a single row. In some implementations, the geographic area can be a circular ring having a radius of 1-10 miles (e.g., 1 mile, 3 miles, 5 miles, 10 miles, etc.), while in other implementations, the geographic area can have a non-circular shape. The visual element also includes PO columns 230A-230G (collectively referred to as PO columns 230), which display information about the various POs that have been issued for each ring candidate. For the purposes of the PO-BOM Summary View, POs are split into six main categories, corresponding to the six PO columns 230A-230G. Column 230A (the “SCIP PO” column) lists POs that were issued to vendors tasked with searching for viable candidate wireless sites. Column 230B (the “MAIN PO” column) lists essential POs such as POs for construction (CX) drawings, lease exhibits, building permits, and lease packages. Column 230C (the “Drone PO” column) lists drone-related POs such as 3D data capture and 3D data processing POs. Column 230D (the “Structural PO” column) lists POs issued for structural analysis. Column 230E (the “A&E PO” column) lists POs issued for architecture and engineering. Column 230G (the “CX Service PO” column) lists POs issued for construction services. Column 230F (the “Other PO” column) lists all other issued POs. These categorizations of POs are just examples, and in some implementations, other categorizations may be readily used.

Referring now to the specific example shown in the screenshot 200, a user has selected SITE ID “DCSBY00078B” from the scrollable list 102, causing information related to the candidate wireless site to populate the visual elements 210, 240. In visual element 210, it is shown that the candidate wireless site of interest is associated with site acquisition vendor “A” and has a launch status of “Performance/Capacity.” In visual element 240 (and specifically column 220), it is shown that the candidate wireless site of interest is the second of two candidate sites (“Ring Candidate A” and “Ring Candidate B”) considered within the same geographic ring.

Referring to the first row of visual element 240, it is shown that a first candidate site (“Ring Candidate A”) was previously considered within the same geographic ring as the candidate wireless site of interest. It is also shown (in column 230A) that a SCIP PO was issued for a first SCIP of the “Ring Candidate A” site. However, no other POs were issued for the site (as shown by the blank first rows of columns 230B-230G).

For one or more reasons, the “Ring Candidate A” site was not pursued for further site development, and a second candidate site was considered. This consideration of a second candidate site is shown by the populated second row of visual element 240, which corresponds to “Ring Candidate B” (i.e., the candidate wireless site of interest having SITE ID “DCSBY00078B”). As shown by the second rows of columns 230B-230D, multiple POs have been issued for “Ring Candidate B” including MAIN POs, Drone POs, and Structural POs. However, no A&E POs or CX Service POs or Other POs have been issued.

In some implementations, one or more indications (e.g., cell color indications, font color indications, font type indications, line type indications, etc.) can be used to distinguish between POs issued for candidate wireless sites that are actively being pursued for site development (e.g., sites having a launch status or launch category of “Launch”) versus candidate wireless sites that are not actively being pursued (e.g., sites having a launch status or launch category of “Performance/Capacity”). These indications can serve as an alert to a user, allowing the user to quickly visually identify issued POs that might be cancellable in order to save costs, particularly if a deliverable associated with the relevant PO has not yet been provided. For example, in the specific case of SITE ID “DCSBY00078B” shown in screenshot 200, the candidate wireless site of interest is a “Performance/Capacity” site that is not actively being pursued for development. Consequently, the cells showing the issued POs for “Ring Candidate A” and “Ring Candidate B” in columns 230A-230D are shown with visually distinct features (e.g., different cell shading) compared to the other cells in visual element 240.

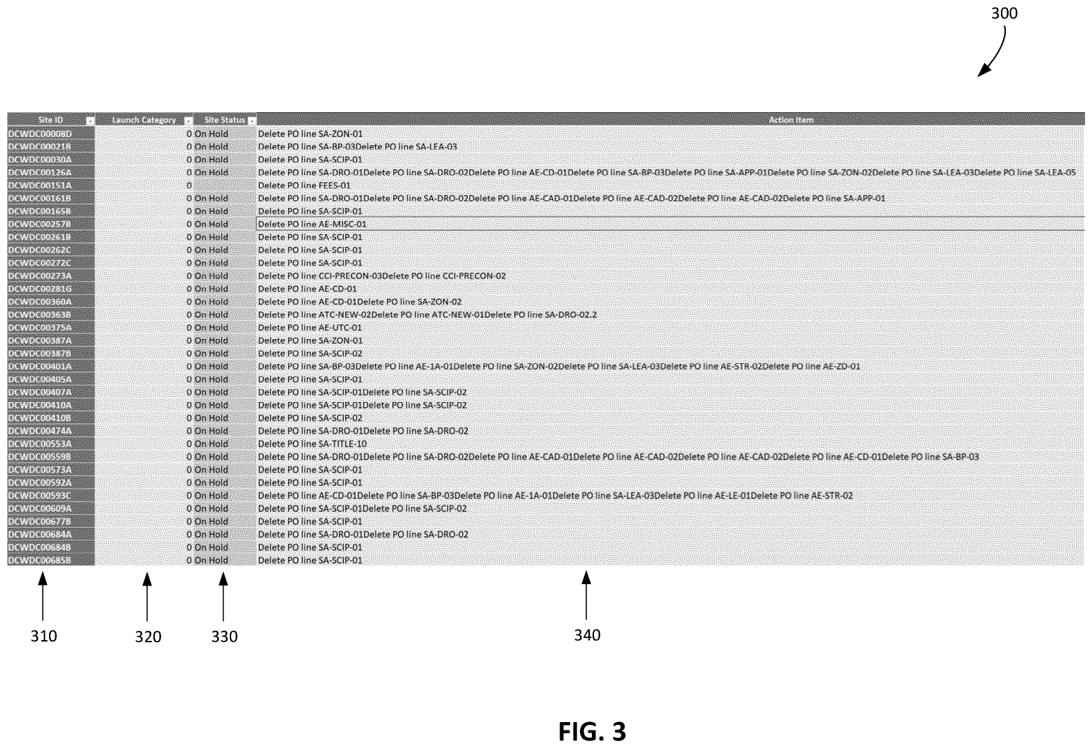

FIG. 3 is another screenshot 300 of a user interface associated with the technology described herein. The screenshot 300 captures a third view (referred to herein as a “Billing Reconciliation Summary View”) of the user interface that, among other things, provides suggestions to a user to cancel (or delete) POs for particular tasks associated with candidate wireless sites that are no longer being pursued for site development. The various information used to generate the Billing Reconciliation Summary View can, in some implementations, be pulled from a local copy of data downloaded from an external source (e.g., one or more external servers owned by a network provider). In other implementations, the information can be pulled directly from the external source (e.g., in real-time).

As shown in the screenshot 300, the Billing Reconciliation Summary View includes a column 310 listing multiple site IDs, with each site ID corresponding to a particular candidate wireless site. Each row of the Billing Reconciliation Summary View displays information corresponding to a single candidate wireless site (and, hence, a single site ID). Column 320 shows a launch category for each candidate wireless site, column 330 shows a site status for each candidate wireless site, and column 340 shows suggestions for cancelling POs (or line items of POs) for particular tasks associated with each candidate wireless site. In some implementations (and as shown in the screenshot 300), the rows shown in the Billing Reconciliation Summary View can be sorted by launch category to display non-launch sites at the top of the screen, since these candidate wireless sites can be more likely to benefit from cancelling outstanding POs. In other implementations, the rows can be sorted by site status to display candidate wireless sites that are “On Hold”, “Fallout”, or “RF Inactive” sites since these candidate wireless sites can also be more likely to benefit from cancelling outstanding POs. In some implementations, the suggestions for cancelling POs for a particular candidate wireless site (shown in the Billing Reconciliation Summary View in column 340) can also be displayed as an alert 136 on the Deployment Summary View of the user interface (described above in relation to FIG. 1).

In some implementations, it is desirable to cancel specific line items (e.g., line items associated with particular tasks) from a PO rather than cancelling an entire PO. For example, in some cases, certain tasks of a PO may already be completed, while other tasks of a PO may not yet have been completed. In such cases, it may only be possible to cancel the line items of a PO associated with uncompleted tasks. As used herein, a “task” can refer to an action item to be performed by a service provider or vendor, against which a PO (or a line item of a PO) can be issued for a particular candidate wireless site. In some implementations, tasks can be classified into subsets of the six PO categories described above in relation to FIG. 2 (shown in columns 230A-230G), using a plurality of task IDs (e.g., 20 task IDs, 50 task IDs, 80 task IDs, 100 task IDs, 150 task IDs, etc.). Examples of task IDs (corresponding to tasks for which PO line items are suggested for cancellation) are shown in column 340 of the screenshot 300 (e.g., “SA-ZON-01”, “SA-BP-03”, SA-LEA-03, etc.) In order to determine which PO line items should be suggested to the user for cancellation, one or more processors of the user device can process data relating to a plurality of candidate wireless sites. As described elsewhere, in some implementations, this data can be accessed as a local copy of data downloaded to the user device from an external source (e.g., one or more external servers owned by a network provider). In other implementations, the information can be pulled directly from the external source (e.g., in real-time).

Processing the data to determine which PO line items should be suggested to the user for cancellation can include analyzing the data to identify whether each candidate wireless site is actively being pursued. For example, for each candidate wireless site, processing the data can include checking a launch category (or launch status) of the candidate wireless site and a site status of the candidate wireless site. Upon determining that the launch category indicates that the site is a “Performance/Capacity” site, the one or more processors can determine that the candidate wireless site is not actively being pursued for site development. Similarly, upon determining that the launch category indicates that the site is a “Launch” site but that the site status is “On Hold”, “Fallout”, or “RF Inactive,” the one or more processors can determine that the candidate wireless site is not actively being pursued for site development. On the other hand, if the launch category indicates that the site is a “Launch” site and that the site status is “Primary,” the one or more processors can determine that the candidate wireless site is actively being pursued for site development.

For all candidate wireless sites that are actively being pursued for site development, the one or more processors can cause a suggestion to be displayed on the user device to indicate that no PO line items should be canceled. This can have the advantage of preventing delays to site development caused by cancellation of POs that are still necessary, but have yet to be fulfilled. In some implementations, rather than actively displaying a suggestion indicating that no PO line items should be canceled, the user device can be configured to present no suggestion at all if no PO line items are recommended for cancellation.

For all candidate wireless sites that are not actively being pursued for site development, processing the data to determine which PO line items should be suggested to the user for cancellation can further include determining whether each PO line item is able to be cancelled. In some implementations, for each PO line item issued against a candidate wireless site, the one or more processors can determine (i) if the PO has been approved, (ii) if the PO line item has not been cancelled, and (iii) if no invoice corresponding to the PO line item has been received. In some implementations, all three of these conditions must be satisfied in order for a PO line item to be cancelled. Upon determining that all three conditions are satisfied, the one or more processors can cause the user device to display a suggestion to cancel the relevant PO line item (e.g., in column 340 of the Billing Reconciliation Summary View or via alert 136 in the Deployment Summary View).

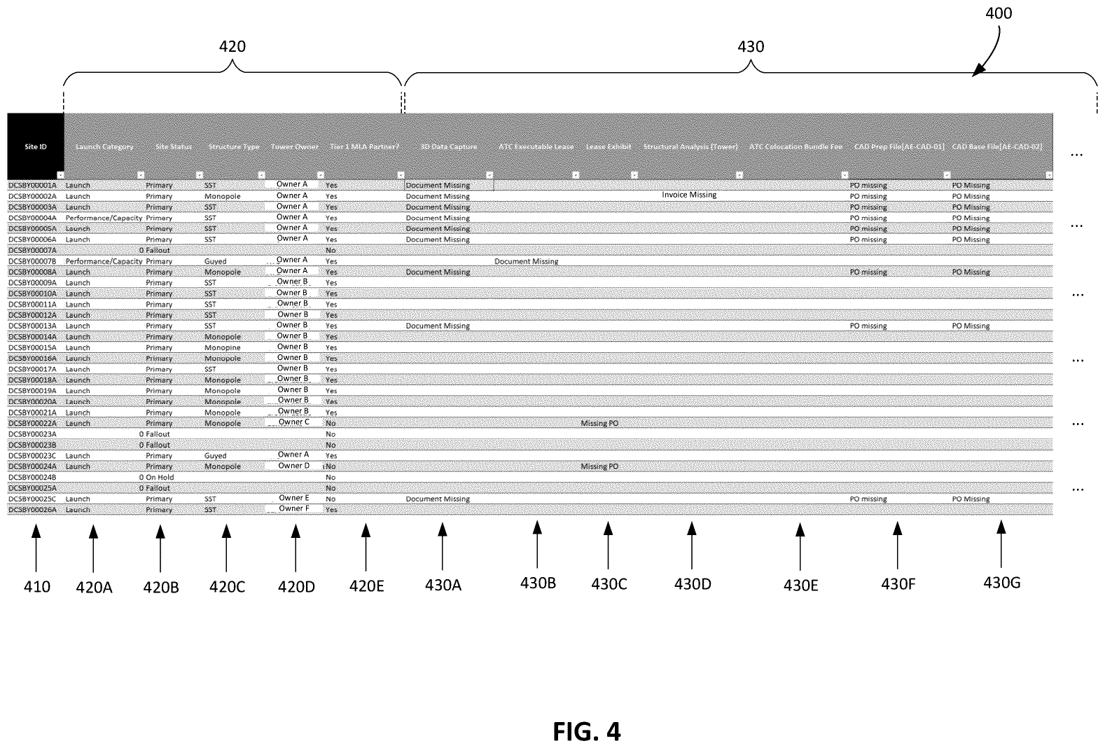

FIG. 4 is another screenshot 400 of a user interface associated with the technology described herein. The screenshot 400 captures a fourth view (referred to herein as an “Pending Actions View”) of the user interface that, among other things, provides a user with a visual summary of any missing task-related deliverable documents, invoices, or POs associated with candidate wireless sites. The various information used to generate the Pending Actions View can, in some implementations, be pulled from a local copy of data downloaded from an external source (e.g., one or more external servers owned by a network provider). In other implementations, the information can be pulled directly from the external source (e.g., in real-time or with a delay ranging from, for example, 30 minutes to 5 hours).

As shown in the screenshot 400, the Pending Actions View includes a column 410 listing multiple site IDs, with each site ID corresponding to a particular candidate wireless site. Each row of the Pending Actions View displays information corresponding to a single candidate wireless site (and, hence, a single site ID). Columns 420A-420D (collectively referred to as columns 420) show basic information about each candidate wireless site including a launch category (column 420A), a site status (column 420B), a structure type (column 420C), a tower owner (column 420D), and an indication of a categorization of the tower owner (column 420E). For example, referring to column 420E, the tower owner can be categorized as a “Tier 1 MLA Partner,” indicating that the tower owner belongs to a particular tier (e.g., Tier 1) and that the network provider has signed a lease agreement (e.g., a Master Lease Agreement) with the tower owner that includes general terms that will be incorporated into any lease agreements for individual candidate wireless sites leased from the tower owner. Columns 430A-430G as well as additional columns extending beyond the screenshot 400 (collectively referred to as columns 430) show information about missing deliverable documents, invoices, and POs for particular tasks associated with each candidate wireless site.

Each of the columns 430 corresponds to a particular task against which POs can be issued, invoices received, and deliverable documents received for each candidate wireless site. For example, in the screenshot 400, column 430A corresponds to a 3D data capture task and visually indicates that a task-related deliverable document is missing for multiple candidate wireless sites. As another example, column 430D corresponds to a structural analysis task and visually indicates that a task-related invoice is missing for one candidate wireless site (i.e., site “DCSBY00002A”). As yet another example, column 430F corresponds to a task for a vendor to provide a computer aided design (CAD) preparatory file and visually indicates that a task-related PO is missing for multiple candidate wireless sites. In some implementations, in addition to simply indicating that the PO, invoice, and/or deliverable document is missing, the columns 430 can include a recommended action that the user can take to resolve the potential issue. For example, in the case of a missing deliverable document, the “Document Missing” indications shown in the columns 430 can include a suggestion that the user contact a vendor responsible for the missing document. In the case of a missing PO, the “PO Missing” indications shown in the columns 430 can include a suggestion that the user issue a PO for the relevant task. In the case of a missing invoice, the “Invoice Missing” indications shown in the columns 430 can include a suggestion that the user contact a vendor responsible for the missing invoice. In some implementations, the indication of a missing PO, invoice, and/or deliverable document as well as the recommended action that the user can take can also be presented as an alert 136 in the Deployment Summary View described in relation to FIG. 1.

In order to determine whether any POs, invoices, and/or deliverable documents are missing, one or more processors of the user device can process data relating to a plurality of candidate wireless sites. As described elsewhere, in some implementations, this data can be accessed as a local copy of data downloaded to the user device from an external source (e.g., one or more external servers owned by a network provider). In other implementations, the information can be pulled directly from the external source (e.g., in real-time).

Processing the data to determine whether a deliverable document is missing can include analyzing the data to determine, for each candidate wireless site, that a PO has been issued for a particular task but that no deliverable document corresponding to the task has been received. Processing the data to determine whether a PO is missing can include analyzing the data to determine, for each candidate wireless site, that a deliverable document corresponding to a particular task has been received, but that no PO was issued for that task. Processing the data to determine whether an invoice is missing can include analyzing the data to determine, for each candidate wireless site, that both a PO and a deliverable document corresponding to a particular task have been received, but that no invoice was received for the task. In response to processing the data to identify one or more of these potential issues, the one or more processors of the user device can generate an alert for presentation on a display of the user device (e.g., alert 136 shown in screenshot 100), the process of which is further described herein.

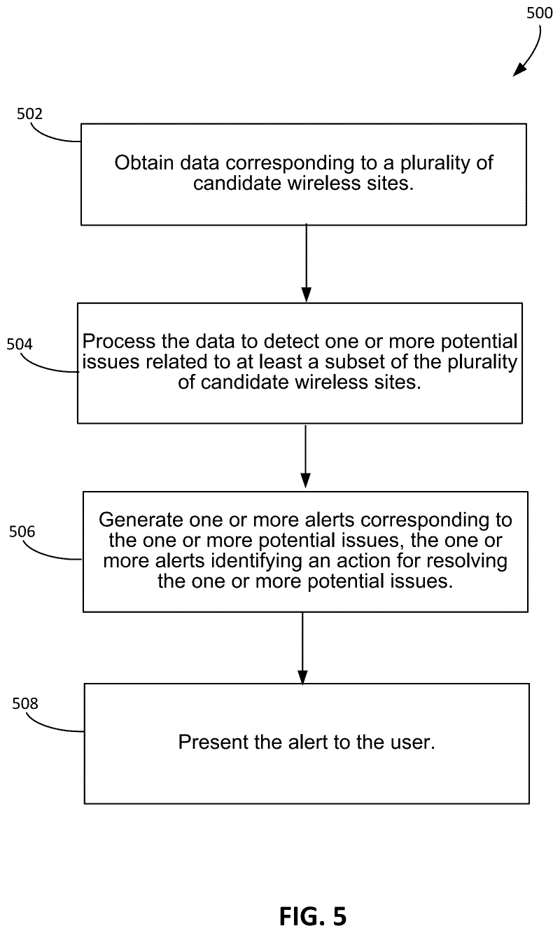

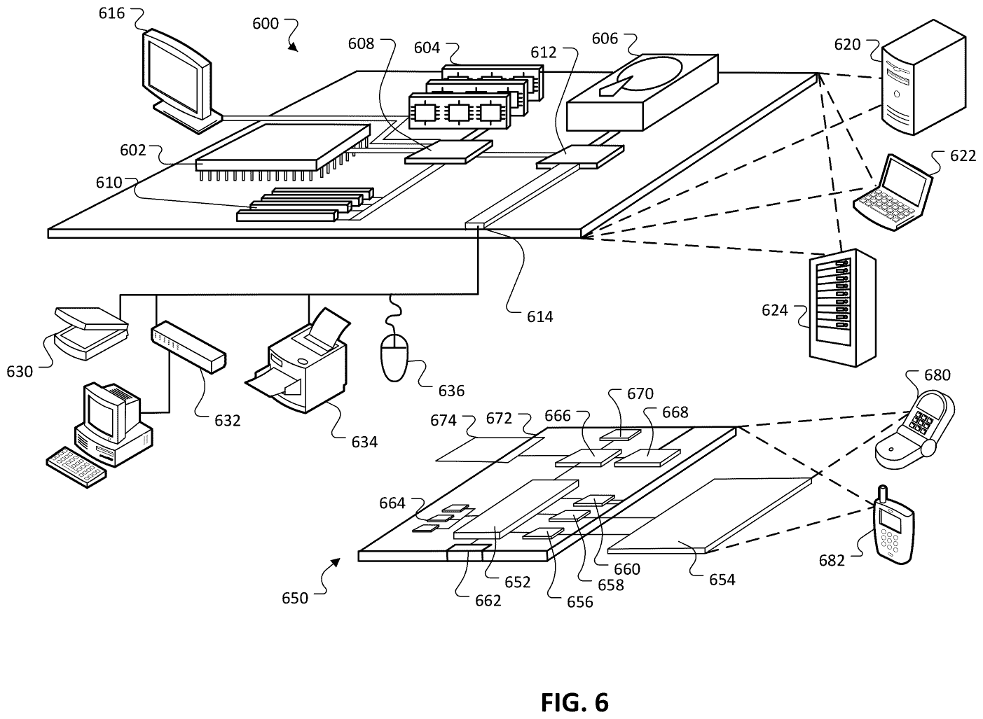

FIG. 5 illustrates an example process 500 for presenting an alert corresponding to one or more potential issues related to at least one candidate wireless site to a user. Operations of the process 500 can be executed by a system that includes a user device (e.g., a computing device and/or a mobile computing device such as those described below in relation to FIG. 6). In some implementations, one or more steps of the process 500 can be performed on an external device (e.g., a cloud server in a cloud computing system) in communication (e.g., wireless communication) with the computing device and/or mobile computing device.

Operations of the process 500 include obtaining data corresponding to a plurality of candidate wireless sites (502). The data can include: an indication of whether each of the candidate wireless sites is actively being pursued for development, a representation of a status of one or more tasks related to developing each of the candidate wireless sites, a record of an issuance or receipt of one or more documents related to the one or more tasks, and a representation of a status of the one or more documents. In some implementations, the data can include data corresponding to more than 100 candidate wireless sites, more than 500 candidate wireless sites, more than 1,000 candidate wireless sites, more than 10,000 candidate wireless sites, etc. The one or more documents can include purchase orders, invoices, and deliverable documents (e.g., documents provided by service providers after performing a deliverable task).

Operations of the process 500 also include, processing the data to detect one or more potential issues related to at least a subset of the candidate wireless sites (504). Operations of the process 500 further include, generating one or more alerts corresponding to the one or more potential issues, the one or more alerts identifying an action for resolving the one or more potential issues (506).

As an example, the one or more potential issues can include the existence of an outstanding purchase order (e.g., a line item of a purchase order that has not been invoiced) corresponding to a candidate wireless site that is no longer being pursued for development. In this example, processing the data can include determining that a purchase order corresponding to at least one candidate wireless site has been approved, determining that at least one line item of the purchase order has not been cancelled, determining that no invoice has been received that corresponds to the at least one line item of the purchase order, and determining that the at least one candidate wireless site is not actively being pursued for development. In this example, generating the one or more alerts at step 506 can include generating the one or more alerts to identify the recommended action of cancelling the line item of the purchase order.

In another example, the one or more potential issues can include a missing invoice corresponding to an issued purchase order. In this example, processing the data can include determining that a purchase order has been issued, and determining that no invoice has been received that corresponds to the purchase order. In this example, generating the one or more alerts at step 506 can include generating the one or more alerts to identify the recommended action of contacting a vendor responsible for supplying the missing invoice.

In another example, the one or more potential issues can include a missing purchase order corresponding to an invoice that has been received. In this example, processing the data can include determining that an invoice has been received, and determining that no purchase order has been issued that corresponds to the invoice. In this example, generating the one or more alerts at step 506 can include generating the one or more alerts to identify the recommended action of issuing the missing purchase order.

In another example, the one or more potential issues can include a missing deliverable document. In this example, processing the data can include determining that a purchase order has been issued, determining that an invoice corresponding to the purchase order has been received, and determining that no deliverable document corresponding to the purchase order or the invoice has been received. In this example, generating the one or more alerts at step 506 can include generating the one or more alerts to identify the recommended action of contacting a vendor responsible for supplying the missing deliverable document.

Operations of the process 500 also include, presenting the alert to the user (508). For example, the alert can be presented to the user on a graphical user interface shown on a display of a user device. Presenting the alert to the user can include presenting the alert with a visualization of at least a portion of the data corresponding to the plurality of candidate wireless sites, wherein an entirety of the visualization is viewable on a display of a user device at one time.

FIG. 6 shows an example of a computing device 600 and a mobile computing device 650 that are employed to execute implementations of the present disclosure. The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 600 and/or the mobile computing device 650 can be user devices that form at least a portion of a system that runs one or more software applications (e.g., Microsoft Excel®, Google Sheets™, Tableau®, a custom-made software application, etc.) to implement the technology described herein. For example, a display 616 of the computing device 600 and/or a display 654 of the mobile computing device 650 can be used to present the user interface of the technology described herein, including the example screenshots 100, 200, 300, 400 shown in FIGS. 1-4 respectively. The computing device 600 and/or the mobile computing device 650 can also be used to perform the process 500 described and shown above in relation to FIG. 5.

The computing device 600 includes a processor 602, a memory 604, a storage device 606, a high-speed interface 608, and a low-speed interface 612. In some implementations, the high-speed interface 608 connects to the memory 604 and multiple high-speed expansion ports 610. In some implementations, the low-speed interface 612 connects to a low-speed expansion port 614 and the storage device 604. Each of the processor 602, the memory 604, the storage device 606, the high-speed interface 608, the high-speed expansion ports 610, and the low-speed interface 612, are interconnected using various buses, and may be mounted on a common motherboard or in other manners as appropriate. The processor 602 can process instructions for execution within the computing device 600, including instructions stored in the memory 604 and/or on the storage device 606 to display graphical information for a graphical user interface (GUI) on an external input/output device, such as a display 616 coupled to the high-speed interface 608. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system). The memory 604 stores information within the computing device 600. In some implementations, the memory 604 is a volatile memory unit or units. In some implementations, the memory 604 is a non-volatile memory unit or units. The memory 604 may also be another form of a computer-readable medium, such as a magnetic or optical disk.

The storage device 606 is capable of providing mass storage for the computing device 600. In some implementations, the storage device 606 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 602, perform one or more methods, such as those described above. The instructions can also be stored by one or more storage devices, such as computer-readable or machine-readable mediums, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards. In the implementation, the low-speed interface 612 is coupled to the storage device 606 and the low-speed expansion port 614. The low-speed expansion port 614, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 614 through a network adapter. Such network input/output devices may include, for example, a switch or router.

The computing device 600 may be implemented in a number of different forms, as shown in FIG. 6. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device, such as a mobile computing device 650. Each of such devices may contain one or more of the computing device 600 and the mobile computing device 650, and an entire system may be made up of multiple computing devices communicating with each other.

The mobile computing device 650 includes a processor 652; a memory 664; an input/output device, such as a display 654; a communication interface 666; and a transceiver 668; among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate. In some implementations, the mobile computing device 650 may include a camera device(s).

The processor 652 can execute instructions within the mobile computing device 650, including instructions stored in the memory 664. The processor 652 may be implemented as a chipset of chips that include separate and multiple analog and digital processors. For example, the processor 652 may be a Complex Instruction Set Computers (CISC) processor, a Reduced Instruction Set Computer (RISC) processor, or a Minimal Instruction Set Computer (MISC) processor. The processor 652 may provide, for example, for coordination of the other components of the mobile computing device 650, such as control of user interfaces (UIs), applications run by the mobile computing device 650, and/or wireless communication by the mobile computing device 650.

The processor 652 may communicate with a user through a control interface 658 and a display interface 656 coupled to the display 654. The display 654 may be, for example, a Thin-Film-Transistor Liquid Crystal Display (TFT) display, an Organic Light Emitting Diode (OLED) display, or other appropriate display technology. The display interface 656 may include appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a Single in Line Memory Module (SIMM) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provided as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 652, perform one or more methods, such as those described above. The instructions can also be stored by one or more storage devices, such as one or more computer-readable or machine-readable mediums, such as the memory 664, the expansion memory 674, or memory on the processor 652. In some implementations, the instructions can be received in a propagated signal, such as, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 668 using a radio frequency. In addition, short-range communication, such as using a Bluetooth or Wi-Fi, may occur. In addition, a Global Positioning System (GPS) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in FIG. 6. Other implementations may include a phone device 680, a personal digital assistant 682, and a tablet device (not shown). The mobile computing device 650 may also be implemented as a component of a smart-phone, AR device, or other similar mobile device.

Computing device 600 and/or 650 can also include USB flash drives. The USB flash drives may store operating systems and other applications. The USB flash drives can include input/output components, such as a wireless transmitter or USB connector that may be inserted into a USB port of another computing device.

Other embodiments and applications not specifically described herein are also within the scope of the following claims. Elements of different implementations described herein may be combined to form other embodiments.

What is claimed is:

1. A method comprising:
obtaining data corresponding to a plurality of candidate wireless sites, the data comprising an indication of whether each of the candidate wireless sites is actively being pursued for development, a representation of a status of one or more tasks related to developing each of the candidate wireless sites, a record of an issuance or receipt of one or more documents related to the one or more tasks, and a representation of a status of the one or more documents;
processing the data, for at least a subset of the candidate wireless sites, to identify one or more line items of a purchase order to recommend for cancellation, wherein processing the data comprises:
determining that the purchase order corresponding to at least one candidate wireless site has been approved;
determining that at least one line item of the purchase order has not been cancelled;
determining that no invoice has been received that corresponds to the at least one line item of the purchase order; and
determining that the at least one candidate wireless site is not actively being pursued for development;
generating one or more alerts comprising an identification of the at least one line item of the purchase order and a recommendation to cancel the at least one line item of the purchase order; and
presenting, on a graphical user interface, the one or more alerts to the user.

2. The method of claim 1, further comprising processing the data to detect a missing invoice, wherein processing the data comprises:
determining that a second purchase order has been issued; and
determining that no invoice has been received that corresponds to the second purchase order.

3. The method of claim 2, further comprising generating a missing invoice alert comprising a recommendation to contact a vendor responsible for supplying the missing invoice.

4. The method of claim 1, further comprising processing the data to detect a missing purchase order, wherein processing the data comprises:
determining that an invoice has been received; and
determining that no purchase order has been issued that corresponds to the invoice.

5. The method of claim 4, further comprising generating a missing purchase order alert comprising a recommendation to issue the missing purchase order.

6. The method of claim 1, further comprising processing the data to detect a missing deliverable document, wherein processing the data comprises:
determining that a second purchase order has been issued;
determining that an invoice corresponding to the second purchase order has been received; and
determining that no deliverable document corresponding to the second purchase order or the invoice has been received.

7. The method of claim 6, further comprising generating a missing deliverable document alert comprising a recommendation to contact a vendor responsible for supplying the missing deliverable document.

8. The method of claim 1, wherein presenting the one or more alerts to the user comprises presenting the one or more alerts with a visualization of at least a portion of the data corresponding to the plurality of candidate wireless sites, wherein an entirety of the visualization is viewable on a display of a user device at one time.

9. The method of claim 1, wherein the data corresponding to the plurality of candidate wireless sites comprises data corresponding to more than 1,000 candidate wireless sites.

10. A computing device comprising:
a display; and
a controller operably connected to the display, the controller configured to execute instructions to perform operations comprising:
obtaining data corresponding to a plurality of candidate wireless sites, the data comprising an indication of whether each of the candidate wireless sites is actively being pursued for development, a representation of a status of one or more tasks related to developing each of the candidate wireless sites, a record of an issuance or receipt of one or more documents related to the one or more tasks, and a representation of a status of the one or more documents;
processing the data, for at least a subset of the candidate wireless sites, to identify one or more line items of a purchase order to recommend for cancellation, wherein processing the data comprises:
determining that the purchase order corresponding to at least one candidate wireless site has been approved;
determining that at least one line item of the purchase order has not been cancelled;
determining that no invoice has been received that corresponds to the at least one line item of the purchase order; and
determining that the at least one candidate wireless site is not actively being pursued for development;
generating one or more alerts comprising an identification of the at least one line item of the purchase order and a recommendation to cancel the at least one line item of the purchase order; and
presenting the one or more alerts to the user on a graphical user interface shown on the display.

11. The computing device of claim 10, wherein the operations further comprise
processing the data to detect a missing invoice, wherein processing the data comprises:
determining that a purchase order has been issued, and
determining that no invoice has been received that corresponds to the purchase order; and
generating a missing invoice alert comprising a recommendation to contact a vendor responsible for supplying the missing invoice.

12. The computing device of claim 10, wherein the operations further comprise
processing the data to detect a missing purchase order, wherein processing the data comprises:
determining that an invoice has been received; and
determining that no purchase order has been issued that corresponds to the invoice; and
generating a missing purchase order alert comprising a recommendation to issue the missing purchase order.

13. The computing device of claim 10, wherein the operations further comprise
processing the data to detect a missing deliverable document, wherein processing the data comprises:
determining that a second purchase order has been issued;
determining that an invoice corresponding to the second purchase order has been received; and
determining that no deliverable document corresponding to the second purchase order or the invoice has been received; and
generating a missing deliverable document alert comprising a recommendation to contact a vendor responsible for supplying the missing deliverable document.

14. The computing device of claim 10, wherein presenting the one or more alerts to the user comprises presenting the one or more alerts with a visualization of at least a portion of the data corresponding to the plurality of candidate wireless sites, wherein an entirety of the visualization is viewable on a display of a user device at one time.

15. The computing device of claim 10, wherein the data corresponding to the plurality of candidate wireless sites comprises data corresponding to more than 1,000 candidate wireless sites.

16. A non-transitory computer readable medium storing instructions that are executable by a processing device, and upon such execution cause the processing device to perform operations comprising:
obtaining data corresponding to a plurality of candidate wireless sites, the data comprising an indication of whether each of the candidate wireless sites is actively being pursued for development, a representation of a status of one or more tasks related to developing each of the candidate wireless sites, a record of an issuance or receipt of one or more documents related to the one or more tasks, and a representation of a status of the one or more documents;
processing the data, for at least a subset of the candidate wireless sites, to identify one or more line items of a purchase order to recommend for cancellation, wherein processing the data comprises:
determining that the purchase order corresponding to at least one candidate wireless site has been approved;
determining that at least one line item of the purchase order has not been cancelled;
determining that no invoice has been received that corresponds to the at least one line item of the purchase order; and
determining that the at least one candidate wireless site is not actively being pursued for development;
generating one or more alerts comprising an identification of the at least one line item of the purchase order and a recommendation to cancel the at least one line item of the purchase order; and
presenting, on a graphical user interface, the one or more alerts to the user.
